(19) United States
(12) Patent Application Publication
(10) Pub. No.: US 2011/0185825 A1
(43) Pub. Date: Aug. 4, 2011

(54) HORSESHOE LOAD CELL

(76) Inventor: Dan Mackie, Calgary (CA)

(21) Appl. No.: 13/004,025

(22) Filed: Jan. 11, 2011

Related U.S. Application Data
(60) Provisional application No. 61/299,772, filed on Jan. 29, 2010.

(51) Int. Cl. G01L 1/04; E21B 47/00

(52) U.S. Cl. 73/862.637; 166/381

(57) ABSTRACT

A horseshoe load cell is designed to aid in optimizing sucker rod oil production, to improve the installation and removal process for polished rod load cells. This device includes top and bottom washers, a retaining plate and associated bolts. The washers may be used to hold the load cell in the proper position on the polished rod. These washers may also be made in a variety of sizes to accommodate a range of polished rod sizes. An anti-rotation bar can be included to eliminate conflicts between load cell cabling and rod-rotator operation. The anti-rotation bar may have a hole for a quick link to absorb cable tension, reserving the cable strain relief for weatherproofing. The combination of the washers, the specially designed arms and the hole placement in the arms centers the load between the strain gauges, maximizing measurement accuracy. Two sets of strain gauges may be placed on each arm symmetrically around the rod string, providing an effective measurement method. Varying arm sizes and hole placements can be included to allow for different load ratings.

### CROSS-REFERENCE TO RELATED APPLICATION

The present application is related to and claims priority from prior provisional application Ser. No. 61/299,772, filed Jan. 29, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of load cells and more specifically relates to horseshoe load cells.

2. Description of the Related Art

Pump jacks are used to pump oil to the surface by a rod which extends from the surface to a downhole pump located in a subterranean producing formation. Load cells may be used in oilfield pump jack installations to track rod loading. Typically, a load cell is a transducer that is used to convert a force into an electrical signal. This conversion is indirect and happens in two stages. First, through a mechanical arrangement, the force being sensed deforms a strain gauge(s), and then the strain gauge in turn converts the deformation (strain) to electrical signals. A load cell usually consists of one-four strain gauges. Traditionally, Wheatstone bridge configurations have been the most popular configuration. The electrical signal output is typically in the order of a few millivolts and requires amplification by an instrumentation amplifier before it can be used. The output of the transducer may be plugged into an algorithm to calculate the force applied to the transducer.

Installations of industry standard doughnut-style load cells have been conventionally used however they are known to be slow and awkward. Using doughnut-style load cells requires that the clamps above the carrier bar be removed so the doughnut load cell can slide down around the polished rod from the very top, and then the rod clamps above the carrier bar must be replaced. The existence of a rod rotator may further complicate installations, since the load cell must be placed below the rod rotator. For large pump jacks in particular, the installation and removal process can be even more complicated, requiring the use of extra equipment, such as a bucket truck. This can introduce additional costs and scheduling delays, making the process both time-consuming and expensive. Further, traditional load cells may be expensive, heavy and cumbersome to work with and thus are not a cost-effective solution for oil companies to use.

Various attempts have been made to solve the above-mentioned problems such as those found in U.S. Pat. Nos. 5,589,633; 3,355,938; 5,464,058; 4,973,226; 4,932,253; 4,644,785; 4,507,055; 4,490,094; 4,307,395; 4,090,405; 3,965,736; 3,527,094; 3,343,409; 1,585,634; 4,363,605; 5,172,591; 4,947,936; 5,182,946; and 4,661,751. This prior art is representative of load cells. None of the above inventions and patents, taken either singly or in combination, is seen to describe the invention as claimed.

Ideally, load cells should require minimal maintenance and, yet, would operate reliably and be manufactured and repairable at a modest expense. Thus, a need exists for a reliable horse shoe load cell system to provide for easy installation and to avoid the above-mentioned problems.

### BRIEF SUMMARY OF THE INVENTION

In view of the foregoing disadvantages inherent in the known load cells art, the present invention provides a novel horseshoe load cell system. The general purpose of the present invention, which will be described subsequently in greater detail is to provide efficient and effective deformation analysis to track polished rod loading in oilfield oil pump installations.

A horseshoe load cell system adapted to be removably attached to a polished rod on an oilfield pump jack is disclosed herein comprising: at least one horseshoe load cell acting as a transducer for converting a measured force acting on the polished rod into an electrical signal via a plurality of strain gauges. The device further comprises an electric circuit connected to the plurality of strain gauges (preferably 8) to establish the electrical signal in relation to the sensed force. Top washers and bottom washers are used to hold the horseshoe load cell in a proper position on the polished rod. Retaining shoulder bolts are also included for removably retaining the horseshoe load cell to the polished rod via the bridle plates. The device additionally has a top bridle plate; a bottom bridle plate; at least one retaining plate; an anti-rotation bar with at least one aperture for a quick link to absorb tension in a load cell cabling, and to eliminate conflicts between the load cell cabling and rod-rotator operation, reserving the cable strain relief solely for weatherproofing. The top and bottom bridle plates are spaced a distance apart via arms. The horseshoe load cell is removably received by the polished rod and secured thereon by the top and bottom bridle plates and retaining plate(s). The combination of the washers, the specially designed arms and the hole placement in the arms centers the load between the strain gauges, maximizing measurement accuracy. Eight gauges may be placed on each arm symmetrically around the rod string, providing an effective measurement method. Varying arm sizes and hole placements can be included to allow different load ratings.

A method for installing a horseshoe load cell system for measuring the load on a polished rod connected between an oilfield pump jack and a downhole pump in a subterranean producing formation is also disclosed herein comprising the steps of: standing the well off, installing the horseshoe load cell by slipping the horseshoe load cell into place placement on the polished rod, inserting top washer shoulder bolt; and reversing the standing off process. The horseshoe load cell system provides convenient, reliable and cost-effective service for oil producing entities.

The present invention holds significant improvements and serves as a horseshoe load cell system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, horseshoe load cell, constructed and operative according to the teachings of the present invention.

FIG. 1 shows a perspective view illustrating a doughnut load cell system in an in-use condition as installed on an oilfield pump jack according to an embodiment of the present invention.

FIG. 2 is a perspective view illustrating the horseshoe load cell according to an embodiment of the present invention of FIG. 1.

FIG. 3 is a perspective exploded view illustrating the horseshoe load cell according to an embodiment of the present invention of FIG. 1.

FIG. 4 is a perspective view illustrating the horseshoe load cell system according to an embodiment of the present invention of FIG. 1.

FIG. 5 is a flowchart illustrating a method of using the horseshoe load cell system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a load cell device and more particularly to a horseshoe load cell as used to improve the optimization of sucker rod oil production. The horseshoe load cell is designed as a specific improvement over doughnut-style polished rod load cells, allowing for easy and efficient installation and removal, as well as cost-efficient repair for in-field service, thereby decreasing down-time expense. The device can be used to replace an existing polished rod load cell, and is lighter than a conventional load cell.

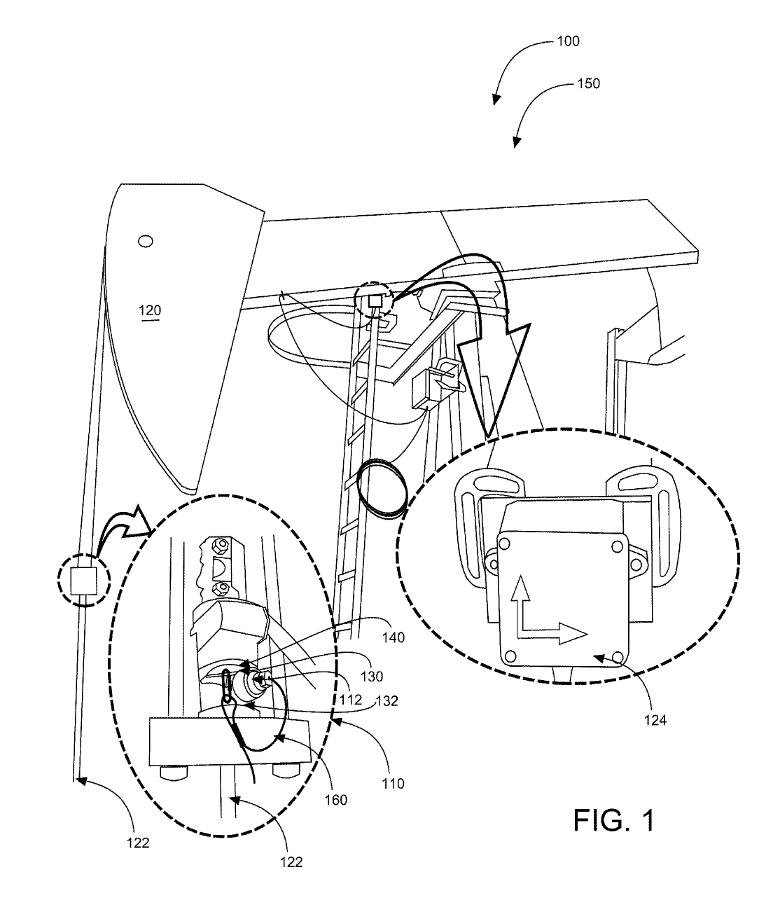

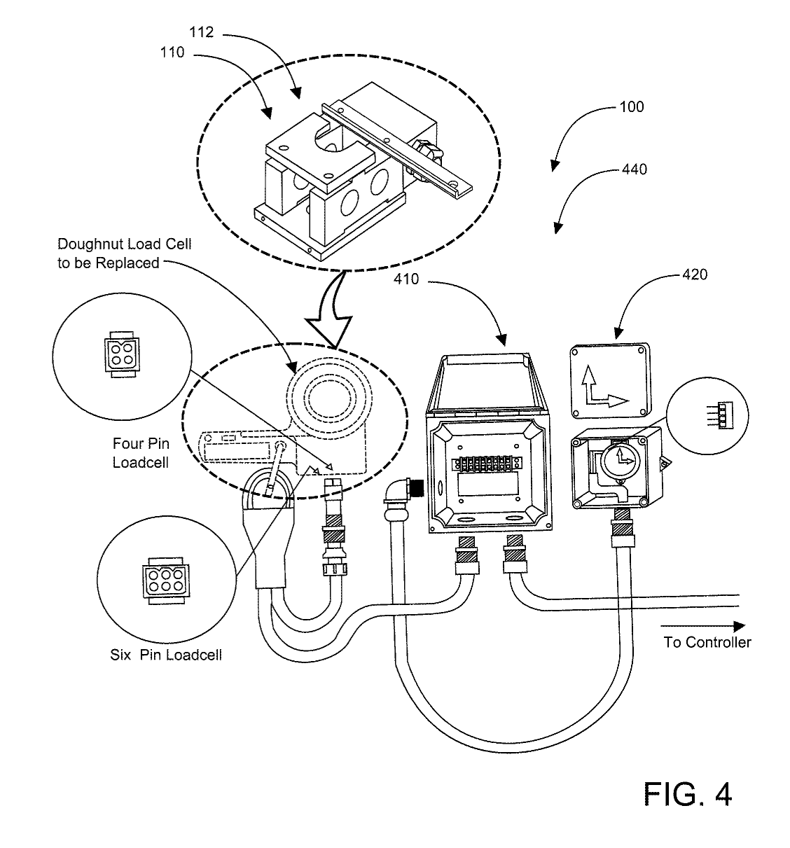

Referring to the drawings by numerals of reference there is shown in FIG. 1 a perspective view illustrating a doughnut load cell system (as replaceable by horseshoe load cell system 100 as demonstrated in FIG. 4) in an in-use condition 150 as installed on oilfield pump jack 120 according to an embodiment of the present invention. This doughnut style load cell is to be replaced with horseshoe load cell 110 as described herein. Stroke device 124 is not considered part of the present invention. Horseshoe load cell system 100 also includes optional upgrading to include an accelerometer, to replace stroke device 124 in existing systems.

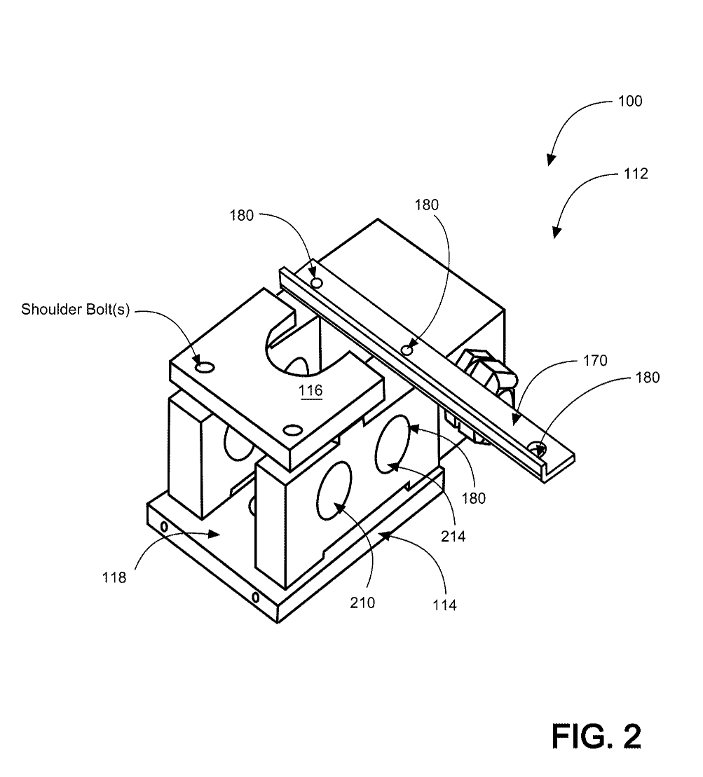

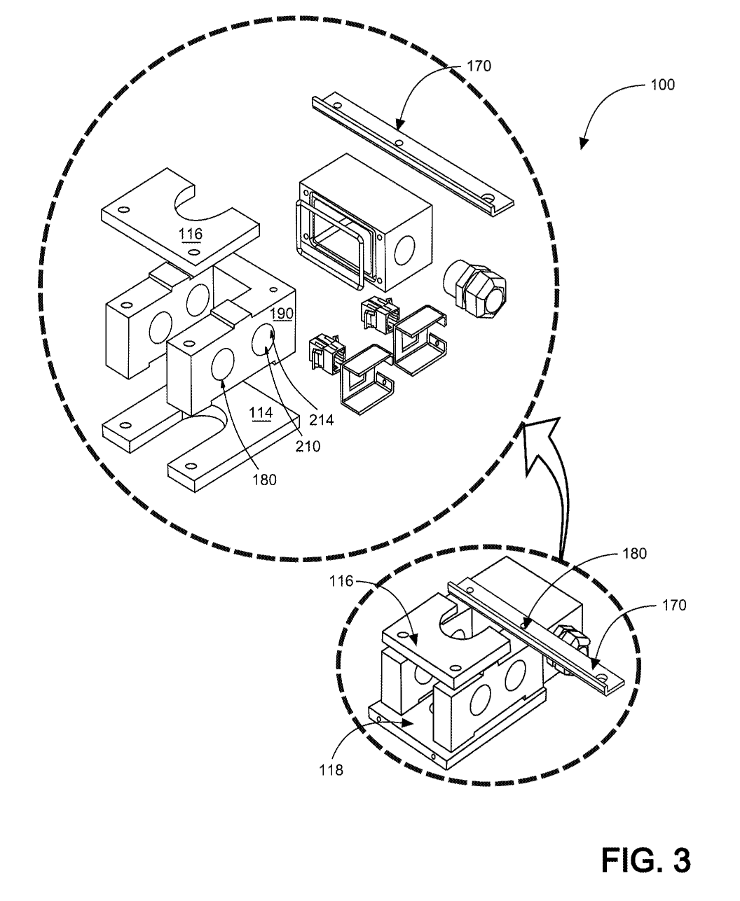

Horseshoe load cell 110, as disclosed herein, is designed to improve the installation and removal process for polished rod load cells, as compared to doughnut-style polished rod load cells. Horseshoe load cell 110 within the present embodiment may be comprised of load cell 112 that includes top and bottom washers 130 and 132, respectively, and (retaining) shoulder bolts 140, as shown in FIGS. 2 and 3. Top washers 130 and bottom washers 132 may be used to hold load cell 112 in the proper position on polished rod 122. It should be appreciated that top washers 130 and bottom washers 132 can also be made in a variety of inner-diameter sizes or with inserts of softer metals to accommodate a range of (OEM) polished rods 122 and reduce associated wear. In this way the present invention may be used on a variety of installations of oilfield pump jacks 120 and may be ‘sized’ to fit polished rods 122 of different diameters.

Referring now to FIGS. 2-4, perspective views and an exploded view, illustrations of horseshoe load cell 110 according to an embodiment of the present invention of FIG. 1.

Horseshoe load cell system 100 is adapted to be efficiently removably attachable to polished rod 122 on oilfield pump jack 120 and preferably comprises: at least one horseshoe load cell 110 acting as a transducer for measuring the force acting on polished rod 122 into an electrical signal via a plurality of strain gauges 210. An electric circuit may be connected to the plurality of strain gauges 210 to establish the electrical signal in relation to the sensed force. Top washers 130 and bottom washers 132, as explained previously, may be used to hold horseshoe load cell 110 in a proper position on polished rod 122.

Horseshoe load cell system 100 may further comprise arms 190; and shoulder bolts 140 for removably retaining horseshoe load cell 110 to polished rod 122. Horseshoe load cell system 100 may further comprise at least one top bridle plate 116; at least one bottom bridle plate 114; at least one retaining plate 118; an anti-rotation bar 170 with at least one aperture 180 for a quick link to absorb tension in a load cell cabling 160, and to eliminate conflicts between load cell cabling 160 and rod-rotator operation, reserving cable strain relief solely for weatherproofing. Top and bottom bridle plates (116 and 114 respectively) are spaced a parallel distance apart via arms 190, as shown to form a boxed configuration. Horseshoe load cell 110 may be removably received by polished rod 122 and secured thereon by top and bottom bridle plates, 116 and 114 respectively, and by retaining plate 118.

A combination of top washers 130 and bottom washers 132, arms 190 and a location of aperture(s) 180 in arms 190 centers a load between strain gauges 210, thereby maximizing measurement accuracy. Strain gauges 210 are preferably placed on each arm 190 symmetrically around polished rod 122. Bottom bridle plate 114, top bridle plate 116 and retainer plate 118 use shoulder bolts in the present embodiment to create a robust coupling and to preserve the integrity of the boxed configuration of horseshoe load cell 110. Retainer plate 118 may be held in place with Allen bolts and lock washers rather than shoulder bolts 140.

Referring now to strain gauges 210 within horseshoe load cell system 100, this particular embodiment preferably comprises eight strain gauges 210 for increased accuracy of measurement. Strain gauges 210 may be suitably and efficiently protected from environmental conditions by pouring apertures 180 full of at least one weather-proof potting compound during manufacturing. In this way the present invention is made more durable and reliable, thus increasing cost-effectiveness and reliability for its users. Wiring to strain gauges 210, may be brought out into a gasketted cavity from a rear portion of horseshoe load cell 110. The gasketted cavity provides sufficient room for related circuitry and for an optional accelerometer for measuring pump stroke activity. Horseshoe load cell 110 output preferably uses 2 mV output per V of excitation. The device provides for adding circuitry to the rear box for different applications, such as stroke measurement in addition to load measurement.

Referring now to location and preferred placement of strain gauges 210 within horseshoe load cell system 100; horseshoe load cell system 100 comprises a plurality of eyes 214 located in arms 190. Eyes 214, as disclosed herein, comprise apertures 180. Apertures 180 comprise through holes, as illustrated. Arms 190, as shown in the present figures have a mechanical load bearing structure and strain gauges 210 are installable in eyes 214. In certain embodiments the sizes of eyes 214 and arms 190 may be larger or smaller according to the user-preferred weight rating as required for the intended application.

Four strain gauges 210 may be preferably installed into apertures 180 drilled through arms 190 in load cell 112. Apertures 180 may be placed at horizontal locations in each arm 190. Arms 190, as designed, have a mechanical load bearing design. The combination of top washers 130 and bottom washers 132, the arms 190 and the location of aperture 180 in arms 190 centers the load between strain gauges 210, thereby maximizing measurement accuracy. Two strain gauges 210 may be placed on each arm 190, preferably symmetrically around polished rod 122, thereby providing an effective measurement method. Varying sizes of arms 190 and locations of apertures 180 can be altered to allow for different load ratings. The present embodiment preferably comprises two strain gauges 210 in each eye 214, for a total of eight strain gauges 210, as previously mentioned. In this way the present invention may more accurately measure load on polished rod 122. The retaining mechanism for top washers 130 and bottom washers 132 comprises a robust shoulder bolt configuration to increase durability and longevity.

Strain gauges 210 are protected from the weather and environmental conditions by pouring apertures 180 full of at least one weather-proof potting compound. The wiring to strain gauges 210 is brought out into a gasketted cavity at the rear of load cell 112, where there is sufficient room for related circuitry (at least herein embodying electric circuit), and for an optional accelerometer for measuring the pump stroke activity, as aforementioned. Additionally, the gasketted cavity may include a ¾ NPT threaded hole for connection of industry standard strain reliefs. The connector in the cavity can be specified to be either four pin or six pin Molex, to match industry standard load cell cabling 160. Load cell 112 output matches industry standard 2 mV output per V of excitation in the preferred embodiment, thereby creating a standardized device that may be retro-fitted with ease to existing installations. It should be appreciated that other than industry standard equipment and values may still be considered within the scope of the invention and that the listed values are provided for exemplary means and not meant to be limiting in any way.

In this particular embodiment an anti-rotation bar 170 can be included to eliminate conflicts between load cell cabling 160 and rod-rotator operation. Anti-rotation bar 170 may have at least one aperture 180 for a quick link to absorb tension in load cell cabling 160, reserving the cable strain relief for weatherproofing. In this way the present invention may be reliable in a variety of climates and environmental conditions. Horseshoe load cell system 100 may be manufactured and provided for sale in a wide variety of sizes and shapes for a wide assortment of applications.

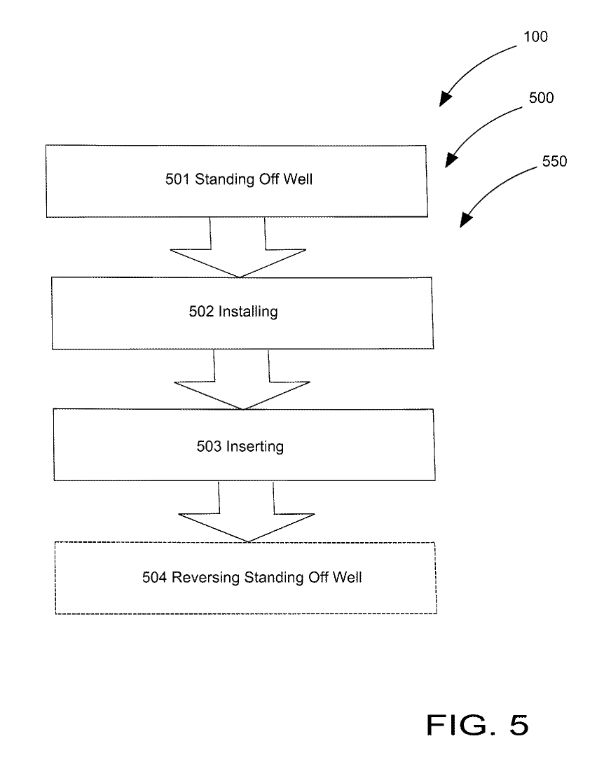

Referring now to FIG. 5, a flowchart 550 illustrating a method of use 500 for horseshoe load cell system 100 according to an embodiment of the present invention of FIGS. 1-4.

A method 500 for installing a horseshoe load cell system 100 for measuring the load (load-measuring) on polished rod 122 connected between an oilfield pump jack 120 and a downhole pump in a subterranean producing formation comprising the steps of: step one 501 standing the well off (at least herein enabling initiating a standing off well process), step two 502 installing horseshoe load cell 110 by slipping horseshoe load cell 110 into place onto polished rod 122, step three 503 inserting top washer 130 with shoulder bolts 140 and retaining plate 118 with Allen bolts; and step four 504 reversing the standing off process. With the present invention no bucket truck is required, regardless of pumpjack size making the use of horseshoe load cell system 100 both convenient and cost-effective in service, a viable solution for oil producing entities. Horseshoe load cell 110 is designed specifically to be cost effective to manufacture, robust in operation, and easy to service in terms of installation and replacement.

It should be noted that step 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A horseshoe load cell system adapted to be removably attached to a polished rod on an oilfield pump jack comprising:
at least one horseshoe load cell acting as a transducer for converting a sensed vertical load force acting on said polished rod into an electrical signal via a plurality of strain gauges;
an electric circuit connected to said plurality of strain gauges to establish said electrical signal in relation to said sensed deformation force;
top washers and bottom washers used to hold said horseshoe load cell in a proper position on said polished rod;
arms;
retaining shoulder bolts and/or allen bolts for removably retaining said horseshoe load cell to said polished rod;
a top bridle plate;
a bottom bridle plate;
at least one retaining plate;
an anti-rotation bar with at least one aperture for a quick link to absorb tension in a load cell cabling, and to eliminate conflicts between said load cell cabling and rod-rotator operation reserving cable strain relief solely for weatherproofing;
wherein said top and bottom bridle plates are spaced via said arms; and
wherein said horseshoe load cell is removably received by said polished rod and secured thereon by said top and bottom bridle plates and said retaining plate.

2. The horseshoe load cell system of claim 1 wherein said horseshoe load cell system comprises eight of said strain gauges.

3. The horseshoe load cell system of claim 2 wherein said strain gauges are protected from environmental conditions by pouring said apertures full of at least one weather-proof potting compound.

4. The horseshoe load cell system of claim 1 further comprising wiring to said strain gauges which is brought out into a gasketted cavity at a rear of said horseshoe load cell.

5. The horseshoe load cell system of claim 4, wherein said gasketted cavity provides sufficient room for related circuitry and for an optional accelerometer for measuring pump stroke activity.

6. The horseshoe load cell system of claim 1 wherein a combination of said top washers and said bottom washers, said arms and a location of said aperture(s) in said arms centers a load between said strain gauges, thereby maximizing measurement accuracy.

7. The horseshoe load cell system of claim 1 wherein said strain gauges are placed on each said arm symmetrically around said polished rod.

8. The horseshoe load cell system of claim 1 wherein said bottom bridle plate, said top bridle plate and said retainer plate use said retaining shoulder bolts to create a robust coupling.

9. The horseshoe load cell system of claim 1 wherein said horseshoe load cell output uses 2 mV output per V of excitation.

10. The horseshoe load cell system of claim 1 further comprising a plurality of eyes located in said arms.

11. The horseshoe load cell system of claim 10 wherein said eyes comprise through holes.

12. The horseshoe load cell system of claim 11 wherein said arms have a mechanical load bearing structure and said eyes wherein said strain gauges are installable therein.

13. A horseshoe load cell system adapted to be removably attached to a polished rod on an oilfield pump jack comprising:
at least one horseshoe load cell acting as a transducer for converting a sensed deformation force acting on said polished rod into an electrical signal via eight strain gauges;
an electric circuit connected to said strain gauges to establish said electrical signal in relation to said sensed deformation force;
top washers and bottom washers used to hold said horseshoe load cell in a proper position on said polished rod;
arms having a plurality of eyes,
wherein said eyes comprise through holes for installing said strain gauges therein,
wherein said arms have a mechanical load bearing structure;
a top bridle plate;
a bottom bridle plate;
wherein said top and bottom bridle plates are spaced via said arms to form a box-like structure;
at least one retaining plate;
wherein said bottom bridle plate and said top bridle plate and said retainer plate use retaining shoulder bolts to create a robust coupling;
said retaining shoulder bolts for removably retaining said horseshoe load cell to said polished rod;
a rear enclosure for storing at least one connector and at least one circuit board;
an anti-rotation bar with at least one aperture for a quick link to absorb tension in a load cell cabling, reserving cable strain relief for weatherproofing and to eliminate conflicts between said load cell cabling and rod-rotator operation;
wherein said strain gauges are protected from environmental conditions by pouring said apertures full of at least one weather-proof potting compound;
wherein said strain gauges are placed on each said arm symmetrically around said polished rod;
wiring to said strain gauges which is brought out into a gasketted cavity at a rear of said horseshoe load cell;
wherein said gasketted cavity includes a ¾ NPT threaded hole for connection of industry standard strain reliefs;
wherein said gasketted cavity provides sufficient room for related circuitry and for an optional accelerometer for measuring pump stroke activity;
wherein said horseshoe load cell output uses 2 mV output per V of excitation;
wherein a combination of said top washers and said bottom washers, said arms and a location of said aperture(s) in said arms centers a load between said strain gauges, thereby maximizing measurement accuracy; and
wherein said horseshoe load cell is removably received by said polished rod and secured thereon by said top and bottom bridle plates and said retaining plate.

14. A method for installing a horseshoe load cell system for load-measuring of a polished rod connected between an oilfield pump jack and a downhole pump in a subterranean producing formation comprising the steps of:
installing a horseshoe load cell by initiating a standing off well process;
slipping said horseshoe load cell into place on said polished rod; and
inserting top washer retaining pins.

15. The method of claim 14 further comprising the step of reversing said standing off well process.
